(19) United States
(12) Patent Application Publication
(10) Pub. No.: US 2018/0121558 A1
(43) Pub. Date: May 3, 2018

(54) WEBPAGE DATA EXTRACTION DEVICE AND WEBPAGE DATA EXTRACTION METHOD THEREOF

(71) Applicant: Institute For Information Industry, Taipei (TW)

(72) Inventors: I-Hsiang HUANG, Taipei City (TW); Yu Shian CHIU, Taoyuan City (TW); Hui-I HSIAO, Yunlin County (TW)

(21) Appl. No.: 15/358,119

(22) Filed: Nov. 21, 2016

(30) Foreign Application Priority Data
Nov. 3, 2016 (TW) 105135730

(51) Int. Cl. G06F 17/30; H04L 29/12; H04L 29/08

(52) U.S. Cl. CPC G06F 17/30887; G06F 17/30896; H04L 67/02; H04L 61/1582

(57) ABSTRACT

A webpage data extraction device and a webpage data extraction method thereof are provided. The webpage data extraction device operates to: group the webpage data into URL groups according to URL relation of the webpage data; select a first webpage data and a second webpage data from each URL group; analyze the first webpage data and the second webpage data to derive a webpage node data set; group webpage node data of the webpage node data set into webpage node data groups according to XPath relation and text content relation of webpage node data of the webpage node data set; calculate respective text content sum for each webpage node data group; determine main webpage node data groups from the webpage node data groups according to the text content sums; decide main content extraction information based on XPath of the webpage node data included in the main webpage node data groups.

### PRIORITY

This application claims priority to Taiwan Patent Application No. 105135730 filed on Nov. 3, 2016, which is incorporated herein for reference in its entirety.

### FIELD

The present invention relates to a webpage data extraction device and a webpage data extraction method thereof. More particularly, the present invention relates to an automated webpage data extraction device and a webpage data extraction method thereof.

### BACKGROUND

With the development of Internet applications, people can obtain various kinds of information from different webpages. Therefore, when particular data needs to be analyzed, people can extract the main content of a webpage on a relevant website for later analysis and processing.

The conventional way to extract the main content of the webpage is mainly conducted through manual crawling and analysis. However, the efficiency of determining the main contents of different webpages on different websites by manual operation is very unsatisfactory. Accordingly, to improve the efficiency in extracting the main content of the webpage, a technology for analyzing a webpage and extracting the main content of the webpage by taking various templates of the webpage and the layout thereof as training data based on a customized program is currently available.

However, the aforesaid technology predominated by the customized program can only process the templates of a particular webpage and the layout thereof. Therefore, even when the layout of the webpage or the implementation of the same layout is just slightly changed, the webpage data extraction can still fail if the customized program is not adjusted accordingly.

Furthermore, as the layout of the webpage format is becoming more complicated, the information amount of the webpage is also increasing remarkably, and there may be up to a thousand of webpage nodes for a single webpage. Accordingly, when the structure or the morphology of the webpage is changed, the adjustment for the customized program will become more difficult, or the customized program may even need to be rewritten. This will also cause a low efficiency in recognizing the main content of the webpage.

Accordingly, an urgent need exists in the art to improve the drawback in the prior art that the efficiency of extracting the main content of the webpage is low.

### SUMMARY

The disclosure includes a webpage data extraction method for a webpage data extraction device. The webpage data extraction device receives a plurality of webpage data from a webpage server. The webpage data extraction method comprises: (a) enabling the webpage data extraction device to group the webpage data into at least one Uniform Resource Locator (URL) group according to address relations of a plurality of URLs of the webpage data, wherein the at least one URL group includes a first URL group, and the first URL group comprises at least a part of the webpage data; (b) enabling the webpage data extraction device to select a first webpage data and a second webpage data from the part of the webpage data of the first URL group; and (c) enabling the webpage data extraction device to analyze the first webpage data and the second webpage data to derive a webpage node data set. The webpage node data set comprises a plurality of webpage node data, each of which comprises a corresponding XML Path Language and a corresponding text content.

The aforesaid webpage data extraction may include: (d) enabling the webpage data extraction device to group the webpage node data of the webpage node data set into a plurality of webpage node data groups according to path relations of the XML Path Languages of the webpage node data of the webpage node data set and text relations of the text contents, wherein each of the webpage node data groups at least comprises a part of the webpage node data; (e) enabling the webpage data extraction device to calculate a text content sum of the part of the webpage node data of each of the webpage node data groups respectively; (f) enabling the webpage data extraction device to determine at least one main webpage node data group from among the webpage node data groups according to the text content sums; and (g) enabling the webpage data extraction device to decide webpage main content extraction information according to the XML Path Languages of the part of the webpage node data comprised in the at least one main webpage node data group.

The disclosure also includes a webpage data extraction device, which comprises a receiving unit and a processing unit. The receiving unit is configured to receive a plurality of webpage data from a webpage server. The processing unit is configured to: group the webpage data into at least one Uniform Resource Locator (URL) group according to address relations of a plurality of URLs of the webpage data, wherein the at least one URL group includes a first URL group, and the first URL group comprises at least a part of the webpage data; select a first webpage data and a second webpage data from the part of the webpage data of the first URL group; and analyze the first webpage data and the second webpage data to derive a webpage node data set. The webpage node data set comprises a plurality of webpage node data, each of which comprises a corresponding XML Path Language and a corresponding text content.

The aforesaid processing unit can be further configured to: group the webpage node data of the webpage node data set into a plurality of webpage node data groups according to path relations of the XML Path Languages of the webpage node data of the webpage node data set and text relations of the text contents, wherein each of the webpage node data groups at least comprises a part of the webpage node data; calculate a text content sum of the part of the webpage node data of each of the webpage node data groups respectively; determine at least one main webpage node data group from among the webpage node data groups according to the text content sums; and decide webpage main content extraction information according to the XML Path Languages of the part of the webpage node data comprised in the at least one main webpage node data group.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a webpage data extraction operation according to a first embodiment of the present invention;

FIG. 1B is a block diagram of a webpage data extraction device according to the first embodiment of the present invention;

FIG. 2A is a schematic view of a webpage data extraction operation according to a second embodiment of the present invention;

FIG. 2B is a block diagram of a webpage data extraction device according to the second embodiment of the present invention;

FIG. 3 is a flowchart diagram of a webpage data extraction method according to a third embodiment of the present invention; and

FIG. 4A to FIG. 4B are flowchart diagrams of a webpage data extraction method according to a fourth embodiment of the present invention.

### DETAILED DESCRIPTION

In the following description, the present invention will be explained with reference to certain example embodiments thereof. It shall be appreciated that these example embodiments are not intended to limit the present invention to any particular examples, embodiments, environment, applications or implementations described in these example embodiments. Therefore, description of these example embodiments is only for purpose of illustration rather than to limit the present invention, and the scope claimed in this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

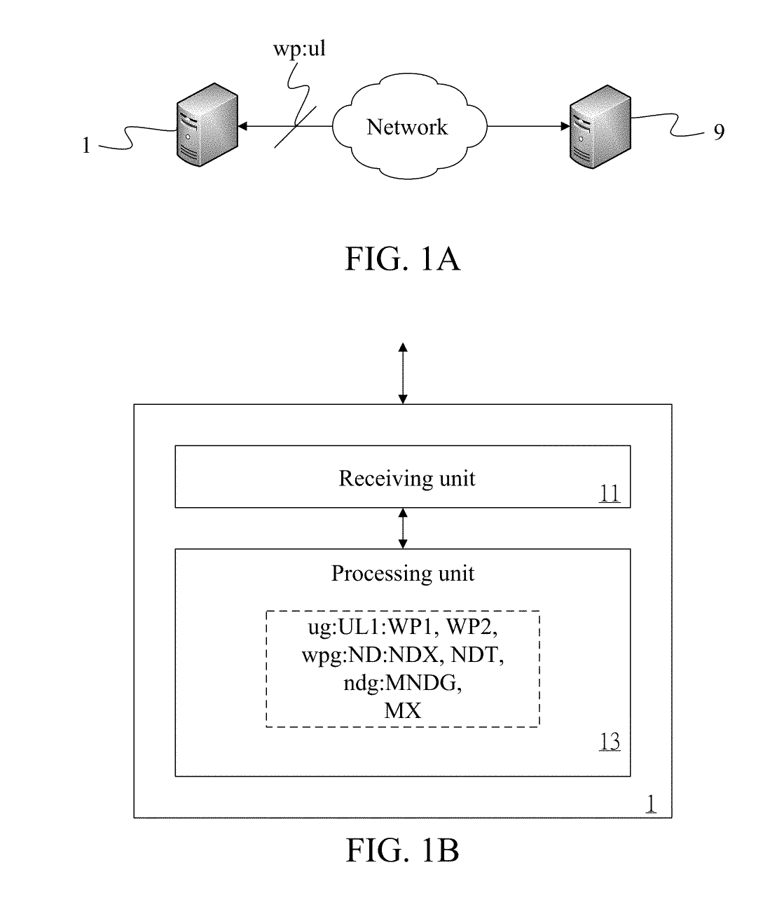

Please refer to FIG. 1A to FIG. 1B. FIG. 1A is a schematic view of a webpage data extraction operation according to a first embodiment of the present invention, and FIG. 1B is a block diagram of a webpage data extraction device 1 according to the first embodiment of the present invention. The webpage data extraction device 1 comprises a receiving unit 11 and a processing unit 13, and is connected to a webpage server 9 via the receiving unit 11. Interactions between the elements will be further described hereinafter.

First, the receiving unit 11 of the webpage data extraction device 1 receives a plurality of webpage data wp from the webpage server 9 when the webpage of the webpage server 9 needs to be analyzed. Based on the use principle of the Internet, each webpage data wp has a corresponding uniform resource locator (URL) ul.

Next, the processing unit 13 of the webpage data extraction device 1 groups the webpage data wp into at least one URL group ug according to address relations of a plurality of URLs ul of the webpage data wp. The at least one URL group ul includes a first URL group UL1, and the first URL group UL1 comprises at least a part of the webpage data wp.

It shall be appreciated that, the intention of grouping the webpage data into groups is to preliminarily sort webpages of which the webpage contents show a relatively high similarity into a group according to the URL characteristics so as to facilitate the subsequent comparison and analysis. In other words, because forms of URL addresses for webpages with the same templates and layouts usually are relatively similar to each other, the grouping can be performed preliminarily according to the address relations of the URLs of the webpage data.

Thereafter, the processing unit 13 of the webpage data extraction device 1 selects a first webpage data WP1 and a second webpage data WP2 from the part of the webpage data of the first URL group UL1, and analyzes the first webpage data WP1 and the second webpage data WP2 to derive a webpage node data set wpg.

In detail, because a single webpage comprises a plurality of webpage nodes, the webpage node data set wpg comprising a plurality of webpage node data ND can be derived by analyzing the grammar of the first webpage data WP1 and the second webpage data WP2. Each of the webpage node data ND comprises a corresponding XML Path Language NDX and a corresponding text content NDT.

Accordingly, the processing unit 13 of the webpage data extraction device 1 can group the webpage node data ND of the webpage node data set wpg into a plurality of webpage node data groups ndg according to path relations of the XML Path Languages NDX of the webpage node data ND of the webpage node data set wpg and text relations of the text contents NDT. Each of the webpage node data groups ndg at least comprises a part of the webpage node data ND.

Similarly, it shall be appreciated that, the intention of grouping the webpage node data into groups is to sort webpage nodes of which the contents show a relatively high similarity into a group according to the characteristics of the XML grammars and the text contents so as to facilitate the subsequent determination for the main content. In other words, the webpage nodes of which the XML grammars show a relatively high similarity are grouped according to the path relations of the XML Path Languages of the webpage nodes, and on the other hand, the webpage nodes of which the contents show a relatively high similarity can also be grouped according to the text relations of the text contents of the webpage nodes.

Next, the processing unit 13 of the webpage data extraction device 1 calculates a text content sum (not shown) of the part of the webpage node data ND of each of the webpage node data groups ndg respectively, i.e., calculates a text total length of the webpage node data ND in a same webpage node data group ndg, and determines at least one main webpage node data group MNDG from among the webpage node data groups ndg according to the text content sums.

Specifically, because the webpage node data comprising the main content usually has the text content of a relatively large amount of data in a same webpage, the aforesaid grouping mainly divides the webpage node data into webpage node data comprising the main content and webpage node data not comprising the main content according to the text content sum of the webpage node data in a same webpage node data group.

Accordingly, the processing unit 13 of the webpage data extraction device 1 can decide webpage main content extraction information MX according to the XML Path Languages NDX of the part of the webpage node data ND comprised in the at least one main webpage node data group MNDG. Further speaking, the webpage main content extraction information MX is mainly a set of the XML Path Languages NDX.

In this way, under the circumstances that the aforesaid URL group comprises webpages of the same property (e.g., the template and the layout), the processing unit 13 of the webpage data extraction device 1 subsequently can select the webpage nodes comprising the main content directly from the URL group according to the set of the XML Path Languages NDX for later use to the analysis and the use of the main content.

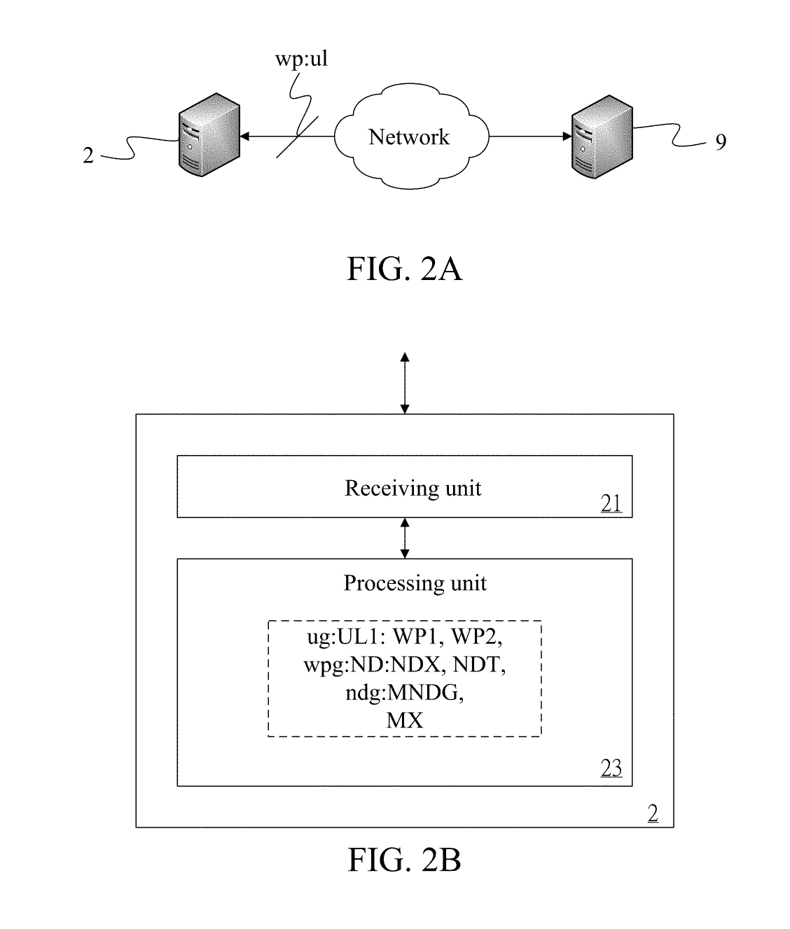

Please refer to FIG. 2A to FIG. 2B. FIG. 2A is a schematic view of a webpage data extraction operation according to a second embodiment of the present invention, and FIG. 2B is a block diagram of a webpage data extraction device 2 according to the second embodiment of the present invention. The webpage data extraction device 2 comprises a receiving unit 21 and a processing unit 23, and is connected to the webpage server 9 via the receiving unit 21. The second embodiment mainly further explains with exemplary examples details of the operation of extracting and analyzing the webpage by the webpage data extraction device 2.

Similarly, the receiving unit 21 of the webpage data extraction device 2 receives a plurality of webpage data wp from the webpage server 9 when the webpage of the webpage server 9 needs to be analyzed. Based on the use principle of the Internet, each webpage data wp has a corresponding uniform resource locator (URL) ul. The webpage data wp and the corresponding URLs ul thereof are as depicted in the following table:

| wp | URL |
|---|---|
| 1 | http://www.aaaaa.com/item1.html |
| 2 | http://www.aaaaa.com/item2.html |
| 3 | http://www.aaaaa.com/item3.html |
| 4 | http://www.aaaaa.com/list1.html |
| 5 | http://www.aaaaa.com/list2.html |
| . . . | . . . |

Next, the processing unit 23 of the webpage data extraction device 2 groups the webpage data wp into at least one URL group ug according to address relations of a plurality of URLs ul of the webpage data wp. The at least one URL group ul includes a first URL group UL1, and the first URL group UL1 comprises at least a part of the webpage data WP. It shall be appreciated that, in the second embodiment, the URL grouping herein is mainly accomplished based on a Minimum Edit Distance (MED).

In detail, the processing unit 23 of the webpage data extraction apparatus 2 calculates the minimum edit distance between any two of the URLs ul of the webpage data wp, and the result is as depicted in the following table:

| MED value | item1.html | item2.html | item3.html | list1.html | list2.html |
|---|---|---|---|---|---|
| item1.html | 0 | 1 | 1 | 4 | 5 |
| item2.html | | 0 | 1 | 5 | 4 |
| item3.html | | | 0 | 5 | 5 |
| list1.html | | | | 0 | 1 |
| list2.html | | | | | 0 |

Accordingly, the processing unit 23 of the webpage data extraction device 2 can add the pair of webpage data of which the MED value is smaller than a URL threshold into a same URL group according to the contents in the above table. For the second embodiment, the URL threshold is 2, so the pair of the webpage data of which the MED value is 1 will be grouped into a same URL group.

In detail, at least a part of the webpage data WP comprised in the first URL group UL1 is http://www.aaaaa.com/item1˜3.html. Additionally, the at least one URL group ul may also comprise a second URL group (not shown), and the second URL group comprises at least a part of the webpage data WP, i.e., http://www.aaaaa.com/list1˜2.html Since the operation of the same URL groups is the same, only the first URL group UL1 will be taken as an example for illustration hereinafter.

Next, the processing unit 23 of the webpage data extraction device 2 selects the first webpage data WP1 having the largest amount of data (i.e., of which the HTML size of the webpage data is the largest) and the second webpage data WP2 having the second largest amount of data from the part of the webpage data of the first URL group UL1, and analyzes the first webpage data WP1 and the second webpage data WP2 to derive a webpage node data set wpg.

In detail, because a single webpage comprises a plurality of webpage nodes, the webpage node data set wpg comprising a plurality of webpage node data ND can be derived by analyzing the grammar of the first webpage data WP1 and the second webpage data WP2. Each of the webpage node data ND comprises a corresponding XML Path Language NDX and a corresponding text content NDT, and the details thereof are as depicted in the following table:

| NDX | NDT |
|---|---|
| . . . | . . . |
| html/head[1]/script[5] | 0 |
| html/body/ . . . /div[2]/p[2] | . . . to be discussed . . . |
| html/body/div[1]/main[1]/article[1] | . . . video equipment . . . |
| html/body/div[1]/main[1]/article[2] | . . . price is too high . . . |
| html/body/div[1]/main[1]/article[1] | . . . share information . . . |
| html/body/div[1]/div[2]/div[2]/div[3]/div[3]/div[6] | Back to homepage |
| html/body/div[1]/main[1]/article[1]/div[1]/div[2] | . . . video equipment . . . |
| html/body/div[1]/main[1]/article[2]/div[1]/div[2] | . . . price is too high . . . |
| html/body div[1]/main[1]/article[1]/div[1]/div[2] | . . . share information . . . |
| html/body/div[1]/div[2]/div[2]/div[3]/div[3]/div[6] | Back to homepage |
| html/body/span[1]/svg[1]/defs[1]/filter[3] | ‘null’ |
| . . . | . . . |

Thereafter, in the second embodiment, invalid or repeated webpage node data ND can be further deleted from the webpage node data set wpg. Specifically, the processing unit 23 of the webpage data extraction device 2 selects at least one invalid text content and at least one repeated node data from the text contents NDT according to the above table. Taking the above table as an example, the invalid text contents are ‘0’ and ‘null’, and the repeated node data is html/body/div[1]/div[2]/div[2]/div[3]/div[3]/div[6]∥ Back to homepage′. Therefore, the contents of the webpage node data ND of the adjusted webpage node data set wpg are as depicted in the following table:

| NDX | NDT |
|---|---|
| . . . | . . . |
| html/body/div[1]/div[2]/p[2] | . . . to be discussed . . . |
| html/body/div[1]/main[1]/article[1] | . . . video equipment . . . |
| html/body/div[1]/main[1]/article[2] | . . . price is too high . . . |
| html/body/div[1]/main[1]/article[1] | . . . share information . . . |
| html/body/div[1]/main[1]/article[1]/div[1]/div[2] | . . . video equipment . . . |
| html/body/div[1]/main[1]/article[2]/div[1]/div[2] | . . . price is too high . . . |
| html/body/div[1]/main[1]/article[1]/div[1]/div[2] | . . . share information . . . |
| . . . | . . . |

Thereafter, the processing unit 23 of the webpage data extraction device 2 can group the webpage node data ND of the webpage node data set wpg into a plurality of webpage node data groups ndg according to path relations of the XML Path Languages NDX of the webpage node data ND of the webpage node data set wpg and text relations of the text contents NDT.

In more detail, the technology for grouping the webpage node data in the second embodiment may be implemented mainly in two stages. In the first stage, similarly the minimum edit distance between any two of the XML Path Languages NDX of the webpage node data ND in the above table is calculated, and the pair of webpage node data ND of which the MED value is smaller than an XML threshold (not shown) is added into a same path group XG. For the second embodiment, the grouping result is as depicted in the following table:

| XG | NDX | NDT |
|---|---|---|
| . . . | . . . | . . . |
| 3 | html/body/div[1]/div[2]/p[2] | . . . to be discussed . . . |
| 4 | html/body/div[1]/main[1]/article[1] | . . . video equipment . . . |
| 4 | html/body/div[1]/main[1]/article[2] | . . . price is too high . . . |
| 4 | html/body/div[1]/main[1]/article[1] | . . . share information . . . |
| . . . | . . . | . . . |
| 9 | html/body/div[1]/main[1]/article[1]/div[1]/div[2] | . . . video equipment . . . |
| 9 | html/body/div[1]/main[1]/article[2]/div[1]/div[2] | . . . price is too high . . . |
| 9 | html/body/div[1]/main[1]/article[1]/div[1]/div[2] | . . . share information . . . |
| . . . | . . . | . . . |

Next, in the second stage, term frequency-inverse document frequency (TF-IDF) calculation is performed on the text content NDT of the webpage node data ND in each of the path groups XG to derive a plurality of corresponding term frequency vectors, and a cosine value between the term frequency vectors of any two of the text contents is calculated. If the cosine value is greater than a text content threshold (not shown), then the two text contents are added into a same webpage node data group ndg. For the second embodiment, the grouping result is as depicted in the following table:

| XG | ndg | NDX | TF-IDF vector of NDT | | | |
|---|---|---|---|---|---|---|
| . . . | | . . . | . . . | . . . | . . . | . . . |
| 3 | 3-1 | html/body/. . ./div[2]/p[2] | 0.8 | 0 | 0 | 0.1 |
| 4 | 4-2 | html/body/div[1]/main[1]/article[1] | 0 | 0.7 | 0.6 | 0 |
| 4 | 4-2 | html/body/div[1]/main[1]/article[2] | 0 | 0.67 | 0.58 | 0 |
| 4 | 4-3 | html/body/div[1]/main[1]/article[1] | 0 | 0.01 | 0.02 | 0.8 |
| . . . | | . . . | . . . | . . . | . . . | . . . |
| 9 | 9-2 | html/body/div[1]/main[1]/article[1]/div[1]/div[2] | 0 | 0.71 | 0.62 | 0.62 |
| 9 | 9-2 | html/body/div[1]/main[1]/article[2]/div[1]/div[2] | 0 | 0.68 | 0.59 | 0 |
| 9 | 9-3 | html/body/div[1]/main[1]/article[1]/div[1]/div[2] | 0 | 0.01 | 0.02 | 0.78 |
| . . . | | . . . | . . . | . . . | . . . | . . . |

In this way, webpage node data groups ndg as depicted in the following table are formed by integrating the grouping in the aforesaid two stages:

| XG | ndg | NDX | NDT |
|---|---|---|---|
| . . . | . . . | . . . | . . . |
| 3 | 3-1 | html/body/ . . . /div[2]/p[2] | . . . to be discussed . . . |
| 4 | 4-2 | html/body/div[1]/main[1]/article[1] | . . . video equipment . . . |
| 4 | 4-2 | html/body/div[1]/main[1]/article[2] | . . . price is too high . . . |
| 4 | 4-3 | html/body/div[1]/main[1]/article[1] | . . . share information . . . |
| . . . | . . . | . . . | . . . |
| 9 | 9-2 | html/body/div[1]/main[1]/article[1]/div[1]/div[2] | . . . video equipment . . . |
| 9 | 9-2 | html/body/div[1]/main[1]/article[2]/div[1]/div[2] | . . . price is too high . . . |
| 9 | 9-3 | html/body/div[1]/main[1]/article[1]/div[1]/div[2] | . . . share information . . . |
| . . . | . . . | . . . | . . . |

It shall be appreciated that, the technology for performing the TF-IDF calculation on the text contents by using key words to derive the relevant vectors and calculating the cosine values between any two of the vectors to determine the vector relations shall be readily appreciated by those skilled in the art based on the prior art, and thus this will not be further described herein and the present invention mainly uses the relations thereof as a basis for the grouping.

Next, the processing unit 23 of the webpage data extraction device 2 calculates a text content sum of the part of the webpage node data ND of each of the webpage node data groups ndg respectively, i.e., calculates a text total length of the webpage node data ND in a same webpage node data group ndg, specifically as depicted in the following table:

| ndg | NDX | NDT | Length | Sum |
|---|---|---|---|---|
| . . . | . . . | . . . | . . . | . . . |
| 3-1 | html/body/. ../div[2]/p[2] | . . . to be discussed . . . | 28 | 28 |
| 4-2 | html/body/div[1]/main[1]/article[1] | . . . video equipment . . . | 35 | 76 |
| 4-2 | html/body/div[1]/main[1]/article[2] | . . . price is too high . . . | 41 | |
| 4-3 | html/body/div[1]/main[1]/article[1] | . . . share information . . . | 73 | 73 |
| . . . | . . . | . . . | . . . | |
| 9-2 | html/body/div[1]/main[1]/article[1]/div[1]/div[2] | . . . video equipment . . . | 37 | 75 |
| 9-2 | html/body/div[1]/main[1]/article[2]/div[1]/div[2] | . . . price is too high . . . | 38 | |
| 9-3 | html/body/div[1]/main[1]/article[1]/div[1]/div[2] | . . . share information . . . | 72 | 72 |
| . . . | . . . | . . . | . . . | . . . |

Next, the processing unit 23 of the webpage data extraction device 2 sorts the text content sums corresponding to different webpage node data groups ndg into a text content sum sequence as depicted in the following table:

| ndg 4-2 | ndg 9-2 | ndg 4-3 | ndg 9-3 | ndg 1-2 | ndg X-X |
|---|---|---|---|---|---|
| 76 | 75 | 73 | 72 | 28 | 27 |

Thereafter, the processing unit 23 of the webpage data extraction device 2 calculates a plurality of difference values, i.e., 1, 2, 1, 44 and 1, of adjacent ones of the text content sums in the text content sum sequence after being sorted, and selects the greatest difference value, i.e., 44. Similarly, because the webpage node data comprising the main content usually has the text content of a relatively large amount of data in a same webpage, the place where the greatest difference value occurs is the boundary between the webpage node data comprising the main content and the webpage node data not comprising the main content.

Therefore, the processing unit 23 of the webpage data extraction device 2 can divide the text content sum sequence into a primary region and a secondary region according to the greatest difference value, and determine the at least one main webpage node data group MNDG of the webpage node data group ndg according to the primary region, as depicted in the following table:

| ndg 4-2 | ndg 9-2 | ndg 4-3 | ndg 9-3 | ndg 1-2 | ndg X-X |
|---|---|---|---|---|---|
| 76 | 75 | 73 | 72 | 28 | 27 |

| | |
|---|---|
| Primary region | Secondary region |
| Main webpage node data group: | Non-main webpage |
| ndg 4-2 \grave{ } ndg 9-2 \grave{ } ndg 4-3 \grave{ } ndg 9-3 | node data group |

Therefore, in the second embodiment, the XML Path Languages NDX of the part of the webpage node data ND comprised in the main webpage node data group MNDG are as depicted in the following table:

| ndg | NDX |
|---|---|
| 4-2 | html/body/div[1]/main[1]/article[1] |
| 4-2 | html/body/div[1]/main[1]/article[2] |
| 4-3 | html/body/div[1]/main[1]/article[1] |
| 9-2 | html/body/div[1]/main[1]/article[1]/div[1]/div[2] |
| 9-2 | html/body/div[1]/main[1]/article[2]/div[1]/div[2] |
| 9-3 | html/body/div[1]/main[1]/article[1]/div[1]/div[2] |

Thereafter, the processing unit 23 of the webpage data extraction device 2 can perform a Longest Common Subsequence (LCS) algorithm on the XML Path Languages NDX of the part of the webpage node data ND comprised in the main webpage node data group MNDG to decide the webpage main content extraction information MX. In the second embodiment, the webpage main content extraction information MX is: ‘html/body/div[1]/main[1]/article[[0-9]+].*’.

In this way, under the circumstances that the aforesaid URL group (i.e., http://www.aaaaa.com/item1˜3.html) comprises webpages of the same property (e.g., the template and the layout), the processing unit 23 of the webpage data extraction device 2 subsequently can select the webpage nodes comprising the same main content extraction information MX (i.e., html/body/div[1]/main[1]/article[[0-9]+].*) for later use to the analysis and the use of the main content.

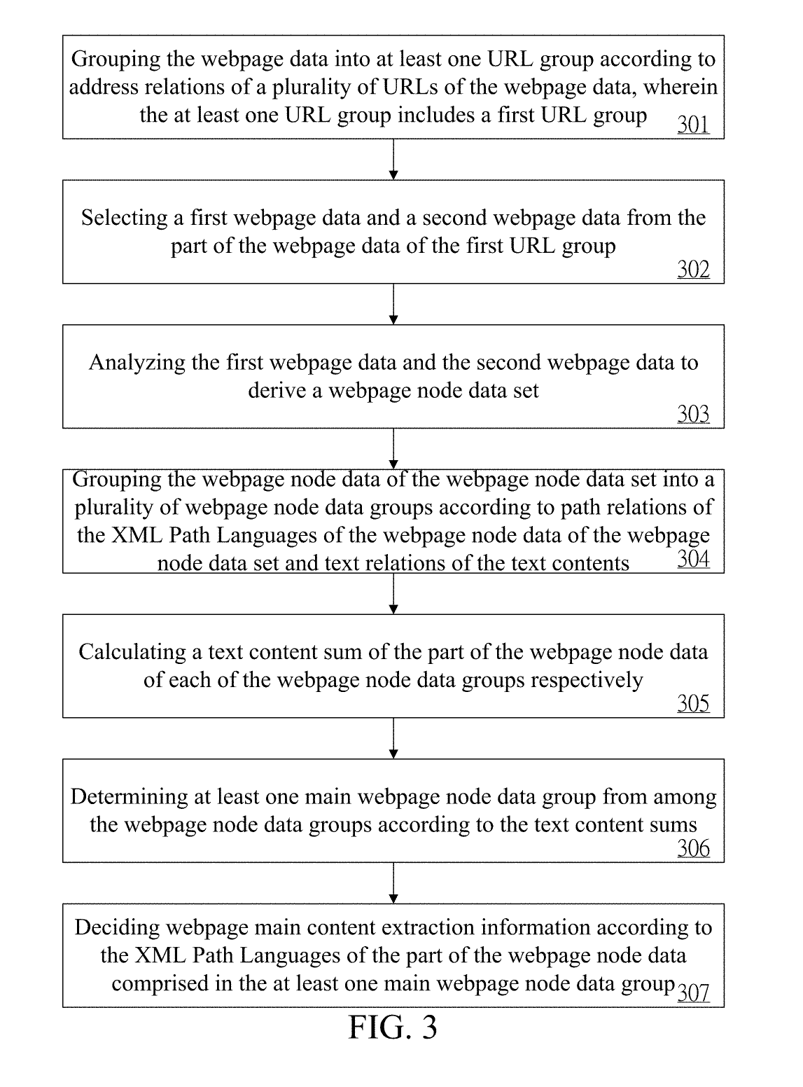

A third embodiment of the present invention is a webpage data extraction method, and a flowchart diagram thereof is as shown in FIG. 3. The method of the third embodiment is used in a webpage data extraction device (e.g., the webpage data extraction device 1 of the aforesaid embodiment). The webpage data extraction device receives a plurality of webpage data from a webpage server. Detailed steps of the third embodiment are as follows.

First, step 301 is executed to enable the webpage data extraction device to group the webpage data into at least one Uniform Resource Locator (URL) group according to address relations of a plurality of URLs of the webpage data. The at least one URL group includes a first URL group, and the first URL group comprises at least a part of the webpage data. Step 302 is executed to enable the webpage data extraction device to select a first webpage data and a second webpage data from the part of the webpage data of the first URL group.

Step 303 is executed to enable the webpage data extraction device to analyze the first webpage data and the second webpage data to derive a webpage node data set. The webpage node data set comprises a plurality of webpage node data, each of which comprises a corresponding XML Path Language and a corresponding text content.

Step 304 is executed to enable the webpage data extraction device to group the webpage node data of the webpage node data set into a plurality of webpage node data groups according to path relations of the XML Path Languages of the webpage node data of the webpage node data set and text relations of the text contents. Each of the webpage node data groups at least comprises a part of the webpage node data.

Step 305 is executed to enable the webpage data extraction device to calculate a text content sum of the part of the webpage node data of each of the webpage node data groups respectively. Step 306 is executed to enable the webpage data extraction device to determine at least one main webpage node data group from among the webpage node data groups according to the text content sums. Finally, step 307 is executed to enable the webpage data extraction device to decide webpage main content extraction information according to the XML Path Languages of the part of the webpage node data comprised in the at least one main webpage node data group.

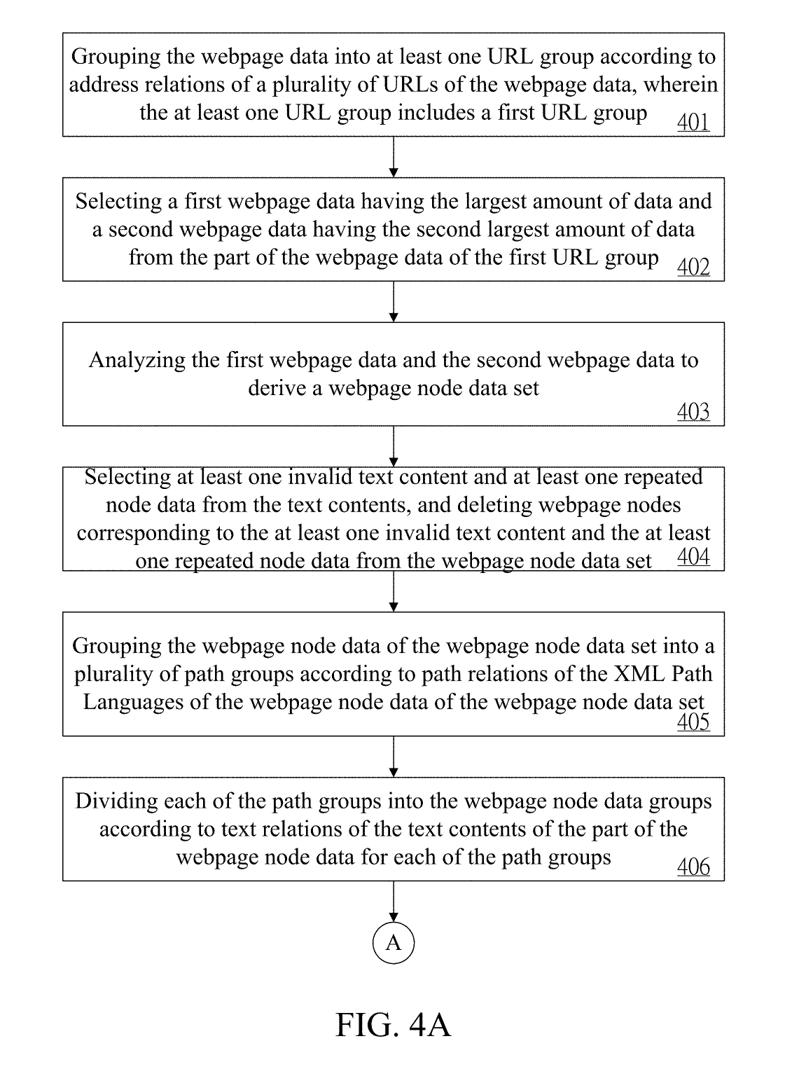

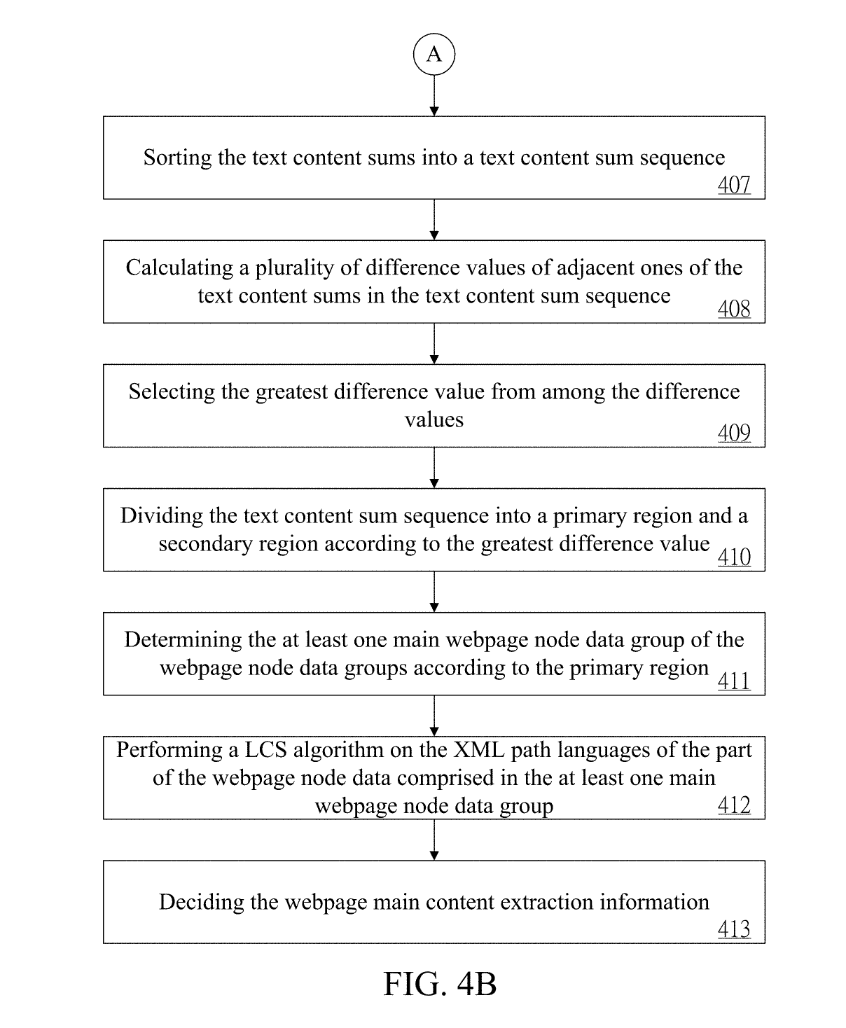

A fourth embodiment of the present invention is a webpage data extraction method, and a flowchart diagram thereof is as shown in FIG. 4. The method of the fourth embodiment is used in a webpage data extraction device (e.g., the webpage data extraction device 2 of the aforesaid embodiment). The webpage data extraction device receives a plurality of webpage data from a webpage server. Detailed steps of the fourth embodiment are as follows.

First, step 401 is executed to enable the webpage data extraction device to group the webpage data into at least one Uniform Resource Locator (URL) group according to address relations of a plurality of URLs of the webpage data. The at least one URL group includes a first URL group, and the first URL group comprises at least a part of the webpage data. In the first URL group, minimum edit distances between the URLs of the part of the webpage data are all smaller than a URL threshold.

Step 402 is executed to enable the webpage data extraction device to select a first webpage data having the largest amount of data and a second webpage data having the second largest amount of data from the part of the webpage data of the first URL group. Step 403 is executed to enable the webpage data extraction device to analyze the first webpage data and the second webpage data to derive a webpage node data set. The webpage node data set comprises a plurality of webpage node data, each of which comprises a corresponding XML Path Language and a corresponding text content.

Step 404 is executed to enable the webpage data extraction device to select at least one invalid text content and at least one repeated node data from the text contents, and delete webpage nodes corresponding to the at least one invalid text content and the at least one repeated node data from the webpage node data set.

Step 405 is executed to enable the webpage data extraction device to group the webpage node data of the webpage node data set into a plurality of path groups according to path relations of the XML Path Languages of the webpage node data of the webpage node data set. Minimum edit distances of the XML Path Languages of the part of the webpage node data of each of the path groups are all smaller than an XML threshold.

Step 406 is executed to enable the webpage data extraction device to divide each of the path groups into the webpage node data groups according to text relations of the text contents of the part of the webpage node data for each of the path groups. Each of the text contents of the part of the webpage node data in each of the path groups has a term frequency vector. Cosine values between the term frequency vectors of the text contents of the part of the webpage node data of each of the webpage node data groups in each of the path groups are greater than a text content threshold.

Step 407 is executed to enable the webpage data extraction device to sort the text content sums into a text content sum sequence. Step 408 is executed to enable the webpage data extraction device to calculate a plurality of difference values of adjacent ones of the text content sums in the text content sum sequence. Step 409 is executed to enable the webpage data extraction device to select the greatest difference value from among the difference values. Step 410 is executed to enable the webpage data extraction device to divide the text content sum sequence into a primary region and a secondary region according to the greatest difference value.

Step 411 is executed to enable the webpage data extraction device to determine the at least one main webpage node data group of the webpage node data groups according to the primary region. Step 412 is executed to enable the webpage data extraction device to perform a Longest Common Subsequence (LCS) algorithm on the XML path languages of the part of the webpage node data comprised in the at least one main webpage node data group. Step 413 is executed to enable the webpage data extraction device to decide the webpage main content extraction information according to the result of the step 412.

According to the above descriptions, the webpage data extraction device and the webpage data extraction method thereof according to the present invention are mainly capable of analyzing automatically the grammar of the templates and the layouts of different webpage groups, and accordingly finding the webpage nodes having the main content automatically. In this way, the extraction of the webpage data can be accomplished more efficiently to facilitate the subsequent analysis of relevant data.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A webpage data extraction method for a webpage data extraction device, the webpage data extraction device receives a plurality of webpage data from a webpage server, the webpage data extraction method comprising:
(a) the webpage data extraction device grouping the webpage data into at least one Uniform Resource Locator (URL) group according to address relations of a plurality of URLs of the webpage data, wherein the at least one URL group includes a first URL group, and the first URL group comprises at least a part of the webpage data;
(b) the webpage data extraction device selecting a first webpage data and a second webpage data from the part of the webpage data of the first URL group;
(c) the webpage data extraction device analyzing the first webpage data and the second webpage data to derive a webpage node data set, wherein the webpage node data set comprises a plurality of webpage node data, each of which comprises a corresponding XML Path Language and a corresponding text content;
(d) the webpage data extraction device grouping the webpage node data of the webpage node data set into a plurality of webpage node data groups according to path relations of the XML Path Languages of the webpage node data of the webpage node data set and text relations of the text contents, wherein each of the webpage node data groups at least comprises a part of the webpage node data;
(e) the webpage data extraction device calculating a text content sum of the part of the webpage node data of each of the webpage node data groups respectively;
(f) the webpage data extraction device determining at least one main webpage node data group from among the webpage node data groups according to the text content sums; and
(g) the webpage data extraction device deciding webpage main content extraction information according to the XML Path Languages of the part of the webpage node data comprised in the at least one main webpage node data group.

2. The webpage data extraction method according to claim 1, wherein minimum edit distances between the URLs of the part of the webpage data in the first URL group are all smaller than a URL threshold.

3. The webpage data extraction method according to claim 1, wherein the step (b) further comprises:
(b1) the webpage data extraction device selecting the first webpage data having the largest amount of data and the second webpage data having the second largest amount of data from the part of the webpage data of the first URL group.

4. The webpage data extraction method according to claim 1, further comprising the following step after the step (c):
(c1) the webpage data extraction device selecting at least one invalid text content and at least one repeated node data from the text contents, and delete webpage nodes corresponding to the at least one invalid text content and the at least one repeated node data from the webpage node data set.

5. The webpage data extraction method according to claim 1, wherein the step (d) further comprises:
(d1) the webpage data extraction device grouping the webpage node data of the webpage node data set into a plurality of path groups according to path relations of the XML Path Languages of the webpage node data of the webpage node data set, wherein minimum edit distances of the XML Path Languages of the part of the webpage node data of each of the path groups are all smaller than an XML threshold; and
(d2) the webpage data extraction device dividing each of the path groups into the webpage node data groups according to text relations of the text contents of the part of the webpage node data for each of the path groups;
wherein each of the text contents of the part of the webpage node data in each of the path groups has a term frequency vector; and
wherein cosine values between the term frequency vectors of the text contents of the part of the webpage node data of each of the webpage node data groups in each of the path groups are greater than a text content threshold.

6. The webpage data extraction method according to claim 1, wherein the step (f) further comprises:
(f1) the webpage data extraction device sorting the text content sums into a text content sum sequence;
(f2) the webpage data extraction device calculating a plurality of difference values of adjacent ones of the text content sums in the text content sum sequence;
(f3) the webpage data extraction device selecting the greatest difference value from among the difference values;
(f4) the webpage data extraction device dividing the text content sum sequence into a primary region and a secondary region according to the greatest difference value; and
(f5) enabling the webpage data extraction device determining the at least one main webpage node data group from among the webpage node data groups according to the primary region.

7. The webpage data extraction method according to claim 1, wherein the step (g) further comprises:
(g1) the webpage data extraction device performing a Longest Common Subsequence (LCS) algorithm on the XML path languages of the part of the webpage node data comprised in the at least one main webpage node data group; and
(g2) the webpage data extraction device deciding the webpage main content extraction information according to the result of the step (g1).

8. A webpage data extraction device, comprising:
a receiving unit, being configured to receive a plurality of webpage data from a webpage server; and
a processing unit, being configured to:
group the webpage data into at least one Uniform Resource Locator (URL) group according to address relations of a plurality of URLs of the webpage data, wherein the at least one URL group includes a first URL group, and the first URL group comprises at least a part of the webpage data;
select a first webpage data and a second webpage data from the part of the webpage data of the first URL group;
analyze the first webpage data and the second webpage data to derive a webpage node data set, wherein the webpage node data set comprises a plurality of webpage node data, each of which comprises a corresponding XML Path Language and a corresponding text content;
group the webpage node data of the webpage node data set into a plurality of webpage node data groups according to path relations of the XML Path Languages of the webpage node data of the webpage node data set and text relations of the text contents, wherein each of the webpage node data groups at least comprises a part of the webpage node data;
calculate a text content sum of the part of the webpage node data of each of the webpage node data groups respectively;
determine at least one main webpage node data group from among the webpage node data groups according to the text content sums; and
decide webpage main content extraction information according to the XML Path Languages of the part of the webpage node data comprised in the at least one main webpage node data group.

9. The webpage data extraction device according to claim 8, wherein minimum edit distances between the URLs of the part of the webpage data in the first URL group are all smaller than a URL threshold.

10. The webpage data extraction device according to claim 8, wherein the processing unit is further configured to:
select the first webpage data having the largest amount of data and the second webpage data having the second largest amount of data from the part of the webpage data of the first URL group.

11. The webpage data extraction device according to claim 8, wherein the processing unit is further configured to:
select at least one invalid text content and at least one repeated node data from the text contents, and delete webpage nodes corresponding to the at least one invalid text content and the at least one repeated node data from the webpage node data set.

12. The webpage data extraction device according to claim 8, wherein the processing unit is further configured to:
group the webpage node data of the webpage node data set into a plurality of path groups according to path relations of the XML Path Languages of the webpage node data of the webpage node data set, wherein minimum edit distances of the XML Path Languages of the part of the webpage node data of each of the path groups are all smaller than an XML threshold; and
divide each of the path groups into the webpage node data groups according to text relations of the text contents of the part of the webpage node data for each of the path groups;
wherein each of the text contents of the part of the webpage node data in each of the path groups has a term frequency vector; and
wherein cosine values between the term frequency vectors of the text contents of the part of the webpage node data of each of the webpage node data groups in each of the path groups are greater than a text content threshold.

13. The webpage data extraction device according to claim 8, wherein the processing unit is further configured to:
sort the text content sums into a text content sum sequence;
calculate a plurality of difference values of adjacent ones of the text content sums in the text content sum sequence;
select the greatest difference value from among the difference values;
divide the text content sum sequence into a primary region and a secondary region according to the greatest difference value; and
determine the at least one main webpage node data group of the webpage node data group according to the primary region.

14. The webpage data extraction device according to claim 8, wherein the processing unit is further configured to:
perform a Longest Common Subsequence (LCS) algorithm on the XML path languages of the part of the webpage node data comprised in the at least one main webpage node data group; and
decide the webpage main content extraction information according to the result of the LCS algorithm.
